(19) United States
(12) Patent Application Publication
(10) Pub. No.: US 2020/0180836 A1
(43) Pub. Date: Jun. 11, 2020

(54) Package Laminate, Blank, Package Sleeve, Package and Packaging with Electrical Elements

(71) Applicant: SIG Technology AG, Neuhausen am Rheinfall (CH)

(72) Inventors: Steffen Reisert, Aachen (DE); Ferdinand Schlappa, Nuernberg (DE); Lars Malindretos, Krefeld (DE)

(21) Appl. No.: 16/632,154

(22) PCT Filed: May 15, 2018
(86) PCT No.: PCT/EP2018/062469

§ 371 Date: Jan. 17, 2020

(30) Foreign Application Priority Data
Jul. 18, 2017 (DE) 10 2017 116 169.4

(51) Int. Cl. B65D 79/02; B65D 65/40; G06K 19/077; G06K 19/07

(52) U.S. Cl. CPC B65D 79/02; B65D 65/40; B32B 7/12; G06K 19/0717; G06K 19/07758

(57) ABSTRACT

Package laminate comprising a multilayer laminate with an outer layer having at least one carrier layer, an electrically conductive barrier layer and a top layer, characterized in that a functional element is arranged on a first side of the barrier layer and in that an electrical element is arranged on the second side of the barrier layer remote from the functional element, the functional element being connected to the electrical element via at least two mutually insulated electrical conductors.

The subject matter relates to package laminates, blanks, package sleeves, packages and packagings which are provided with electronic elements which serve in particular to monitor the condition of the packaged goods.

Packagings can be produced in various ways and from various materials. A widespread possibility of their production is to produce packaging from a package laminate with a laminate based on a fibrous material, especially cardboard, by means of folding and sealing processes. There are essentially two established processes for this purpose.

In the first process, a tube is formed from a package laminate, preferably unwound from a roll, in its direction of travel (longitudinal direction), while the resulting package is usually sealed along its longitudinal seam by inserting a sealing strip. The product to be protected by the resulting package is filled into this tube and the filled tube is sealed and separated transverse to the running direction in portions at predetermined points. The semi-finished composite packagings (“cushions”) produced in this way are then folded and sealed to produce finished composite packagings.

In a second process, individual blanks are produced by cutting the package material, which is also initially available as a package laminate lengthwise and/or crosswise, from which blanks by folding and other steps, such as sealing along sealing edges, first a package sleeve and then a packaging are created. One of the advantages of this method of production is that the blanks and package sleeves are very flat and can therefore be stacked to save space. In this way, the blanks or package sleeves can be produced at a different location than the folding, sealing and filling of the package sleeves. Here, too, laminates (=composite materials) are used which are based on a carrier layer containing a fibrous material, in particular cardboard.

This type of packaging is used in particular in the food industry to a large extend.

Depending on whether a composite packaging is to offer protection for a few days up to a few weeks for a so-called freshly filled product or whether it is to protect a “germ-free” foodstuff filled under aseptic conditions with at least a liquid portion over a long period of time under ambient conditions, very different requirements sometimes arise.

In the case of a freshly filled product, even if it is a so-called “extended shelf life product”, the period in which the contents of the composite packaging are to be protected is very clear and ranges from a few days to several weeks. On the other hand, the properties of the product itself usually have strongly variances. For example, the number of germs in the product varies significantly from batch to batch of the same product, making it difficult to determine the initial conditions.

A “germ-free” product filled under aseptic conditions, on the other hand, presents completely different problems. There are indeed defined conditions around which the composite packaging, which usually comprises of tens of thousands or even several tens of thousands, fluctuate during one hour of production time on a single filling machine. However, the individual composite packagings are then subjected to different stresses and strains as they continue to exist, so that the stresses to which the product to be protected is exposed, e.g. due to transport and storage conditions, over a long period of up to one year or even longer are hardly predictable in individual cases.

Long-term protection of a foodstuff is generally referred to as when the product can be protected in its full quality for months uncooled in composite packaging. The product is then generally filled aseptically into the resulting composite packaging. In the case of UHT milk and juices, it can often be assumed that the contents of the composite packaging will last for up to a year, sometimes even longer.

In order to protect the consumer from consuming a foodstuff that poses a health risk, the legislator prescribes a uniform solution despite the almost contradictory problems just described, namely the labelling of composite packaging with a so-called “best-before date”.

With this concept, the manufacturer must guarantee that the product contained in the composite packaging is harmless to health until the best-before date is reached and, if indicated on the package, its quality at least corresponds to the stated nutritional values. This automatically means that the stated best-before date is estimated extremely carefully, so that the majority of composite packaging also contains a product that is completely harmless to health—in some cases well—beyond the expiry date of the best-before date.

Nevertheless, the indication of the best-before date leads to the fact that today the consumer usually no longer tests the product himself, but usually disposes of the unopened composite packaging after the best-before date has expired.

Publication EP 2 071 496 A1 describes a process for manufacturing a package material in which information about a package and a product can be stored using a radio-readable memory, in particular an RFID chip. The memory is incorporated into a composite material and can also be arranged in different layers of the composite material. The information can, for example, contain information on a best-before date.

A disadvantage of this state-of-the-art solution, however, is that the information is stored statically and that contacting through the metal layer is not possible because the metal layer would cause an electrical short circuit of the contacts.

It is therefore an object to enable communication between an inner side of a metallic barrier layer and an outer side of a metallic barrier layer. It is another object to inform the consumer about the actual quality condition of the contents of a liquid-tight composite packaging. In particular, the consumer should receive information as to whether the consumption of the contents of the composite packaging is harmless at the time of testing.

To solve this object, a package laminate according to Claim 1, a blank according to Claim 12, a package sleeve according to Claim 22, a package according to Claim 23 and packaging according to Claim 24 are proposed.

It has been recognized according to the subject matter that information can only be transmitted electrically from the inside of a package to the outside if the metallic barrier layer is broken through. In order to be able to electrically control a functional element inside the packaging and, if necessary, to be able to read out information, it is necessary to have at least a two-wire connection with an electrical element on the outside. This is achieved by at least two electrically insulated conductors through the barrier layer.

For example, a package laminate (hereinafter also referred to as package material) is produced as bulk web material. This can be formed as a composite of one or more thin layers comprising at least a carrier layer, a barrier layer, a top layer and an outer layer. The outer layer can also be referred to as the top layer. The exact structure of the laminate (composite material) usually depends essentially on the desired degree of protection. For example, laminates (composites) used in the manufacture of packaging to provide long-lasting protection for the at least partially pourable, pasty and/or liquid product to be stored in it have a barrier layer forming an additional gas barrier, especially if the product or parts of the product are sensitive to air, especially oxygen.

Firstly, it is proposed that the package material be a multi-layer laminate. At least one carrier layer can be bonded to an electrically conductive barrier layer. In addition, at least one top layer may be provided which is bonded to at least the barrier layer.

A functional element can be arranged on a first side of the barrier layer to detect conditions inside a package obtained after processing the package material.

In addition, an electrical element can be arranged on the second side of the barrier layer facing away from the functional element.

The functional element can be an electrical, electronic, chemical and/or electrochemical element. The electrical element may contain both electrical and electronic components.

It has now been recognized that an electrical connection between the two elements is made possible by at least two electrical conductors. It is proposed that the functional element is connected to the electrical element by at least two insulated electrical conductors. During operation, the electrical conductors can have two different electrical potentials and can therefore be used for signal transmission in addition to supplying power to the functional element inside the package.

For the first time it is possible to provide an electrical connection between the inside of a package and the outside of a package when using a metallic barrier layer. Previously, it was assumed that damage to the barrier layer would also be detrimental to the tightness of the packaging. However, it has been recognized that such a fear is unfounded if the conductors are appropriately arranged, as will be discussed below.

In special cases, even a single electrical conductor may be sufficient. This can be electrically insulated from the barrier layer and passed through the barrier layer or formed by the barrier layer itself. Such an embodiment can also be inventive on its own and can be combined with all the features described here. In this context, it should be expressly pointed out that the features described herein may be inventive independently and in combination with other features described herein, even by circumventing individual or all features of the independent claims.

According to an embodiment, the first functional element has a sensor. According to an embodiment, the electrical element has a transmitter and/or an antenna.

The antenna (antenna unit) can comprise at least one conductor path, preferably in the form of a conductor spiral or conductor coil, and/or connections for connecting the antenna unit to a chip unit. The antenna unit and the chip unit can also be arranged on a common carrier. The antenna unit enables reading the stored information of the chip unit. Radio antennas are preferably meant, as they are typically used with RFID (Radio Frequency Identification) transponders or NFC (Near Field Communication) tags. Elements that can be read out by inductive coupling in particular can be regarded as antenna units in the present sense. Furthermore, it can be useful if the antenna unit includes a carrier element for holding the conductor path.

The transmitter and/or the antenna can be suitable as part of a transmitting and receiving unit to transmit data, signals and/or energy contactlessly or wirelessly unidirectionally, preferably bidirectionally.

If the properties of the sensor are described below or the term sensor is used, this description also applies to another functional element which is arranged or connected in the area of the top layer, in particular the top layer facing or away from the product.

The sensor is advantageously arranged to detect at least one property of a pasty and/or liquid product packaged in the packaging, in particular at least partially pourable. The sensor can be arranged directly at least in parts on the outer side of the top layer or can break through the top layer in the direction of the product. Thus the sensor can be suitable for the direct detection of at least one property of the product. The sensor can also be provided at least in parts within the top layer and in particular between the top layer and the carrier layer. The sensor may then be suitable for indirect detection of at least one property of the product.

The sensor may be arranged to measure pH, temperature, oxygen content, the proportion of one or more vitamins/trace elements, electrical conductivity, metabolic products or the like. It may be advantageous if the sensor is arranged to determine at least one absolute value.

It is advantageous if two measured values are used to determine the current quality of the food. This can be the same parameter, whereby the sensor measures the measured value, e.g. a pH value, for the first time e.g. when it comes into contact with the product and then measures a change in the measured value without knowing the actual quantitative value.

The sensor is therefore preferably a sensor that records a qualitative change in a measured value. It can therefore be advantageous in some cases if the sensor is arranged to determine at least one relative value of the measured value relative to an initial measured value.

More than one sensor can also be used to determine different parameters. Since, for example, the temperature of the product under investigation still oftentimes affects the determination of the sensor's value currently, it is important for the correctness of a derived condition determination of the quality that the determination of the value is assessed on the basis of the existing temperature. It is therefore proposed that a measured value of a first sensor be weighted and/or normalized depending on a measured value of a second sensor, in particular a temperature value of a temperature sensor.

The sensor advantageously comprises a first region and a second region, wherein the first region is formed open to its surroundings, in particular perforating the top layer in the direction of the product, and the second region is formed at least partially isolated from its surroundings, in particular covered by the top layer in relation to the product.

At least part of the surface of the top layer directed towards the product and/or the sensor advantageously forms a preferred area of residence for at least one object to be detected.

In addition, embodiments of partially or completely printable sensors based on the principle of an ion-sensitive field-effect transistor (ISFET) or electrolyte-insulator-semiconductor (EIS) are possible. Here, the standard materials of silicon technology are completely or partially replaced by functional inks based on polymers with the same or similar electrical or electrochemical properties as the conventional materials. The structures are created with different printing processes, e.g. screen printing or ink jet printing on a substrate, especially the top layer. In addition to its function as a carrier of the sensor structure, the substrate can itself serve as a functional part of the sensor structure, e.g. as an insulator, semiconductor or ion-sensitive layer. Single-layer, multi-layer, rigid or flexible substrates in the form of e.g. foils, plates, sheets, strips, etc. can serve as substrates. In particular, the combination of partially or completely printed sensor structures from functional inks on flexible foil substrates as carriers enables cost-effective production, even in smaller quantities.

In connection with this invention, the cost-effective provision of a sensor is particularly important because the package material, or rather the web material, is used to produce composite packaging. In the sense of the present invention, composite packaging is intended in particular to protect a freshly or preferably aseptically filled foodstuff and is therefore generally disposed of after consumption of the foodstuff. If low-cost sensors are even available for small quantities, it is also possible to produce corresponding forms of package material for less common package forms and/or packages for less common foods at low cost.

With regard to the sensors which work with a potentiometric measuring method, however, the mandatory requirement of a reference electrode represents a general disadvantage. A reference electrode is required to provide a constant potential against which the electrode potential of the measuring electrode can be tapped. The most common form of the reference electrode is a silver-silver chloride (Ag/AgCl) electrode.

Reference electrodes have the disadvantage that the smaller they are, the more unstable their equilibrium potentials are. In addition, most material pairings, e.g. Ag/AgCl, are undesirable when they come into contact with food, especially if chlorides could be introduced into the food (e.g. because the food is particularly receptive to chlorides or certain other parameters are met).

It is therefore preferable that the sensor is equipped with a so-called pseudo-reference electrode as a replacement for a reference electrode. These are simple metal wires or metal surfaces on which a constant but unknown potential is also generated in an electrolyte solution. This makes the measurement of the potential difference less accurate compared to an Ag/AgCl reference electrode, for example. This variant is preferred in particular for applications in which a transition from e.g. chlorides into the measuring medium is to be avoided, especially for consumer goods.

A measuring setup that does not require a reference electrode is based on the principle of redox recycling and is therefore particularly preferred. A measurable current is generated by alternately applying a potential to two electrodes in the analyte solution, for example the product to be analyzed, especially food, or a component or a parameter of the food to be analyzed, which is generated by redox reactions of the analyte at the electrodes. The measurable current is directly or indirectly related to the analyte concentration. In a particularly simple version, a corresponding sensor comprises of exactly two electrodes. However, multi-electrode arrangements are also conceivable, including a reference electrode. The electrodes can be arranged as simple metal wires or completely or partially structured, flat electrode structures. For example, the manufacturing processes and substrate materials described analogously to the ion-sensitive field effect transistors (ISFET) and the EIS (Electrolyte Insulator Semiconductor) sensors can be used to manufacture the electrode structures. Here, too, the use of functional inks in combination with various printing techniques makes it possible to realize cost-effective sensor structures on foil substrates, especially the top layer.

The sensor is advantageously arranged as a temperature sensor. In some cases it may be advantageous to use an active temperature sensor. Active temperature sensors generate an electrical signal based on their measuring principle. This has the advantage that no electrical auxiliary energy is required. An example of such an active temperature sensor is the thermocouple. In this case in particular, a conductor electrically insulated from the barrier layer can be sufficient.

In other cases, it may be preferable for the temperature sensor to be arranged as a passive temperature sensor. In contrast to active sensors, passive temperature sensors require auxiliary power to read out the signal. An example of a passive temperature sensor is the resistance thermometer. It is an electrical component that exploits the temperature dependence of the electrical resistance of an electrical conductor to measure the temperature. Pure metals are the preferred resistance material. They show stronger resistance changes than alloys. They also have an almost linear relationship between resistance and temperature. Platinum is often used.

However, measuring resistors made of ceramic (sintered metal oxides) or semiconductors can also be used. This makes it possible to achieve much higher temperature coefficients than with metals and thus also much higher sensitivities, but in some cases at the expense of accuracy.

Today, both thermocouples and various types of resistance thermometers can be produced cost-effectively using printing techniques.

It is advantageous that at least one of the at least one sensors is a conductivity sensor.

A conductivity sensor can be used to determine the electrical conductivity of liquids in particular. The conductivity is the sum parameter of all dissociated substances (ions) dissolved in the liquid. This is of particular advantage if a packaging is produced from the web material (package material) which serves to preserve a product, preferably a foodstuff, having at least one liquid component. Here, the embodiments takes advantage of the fact that the electrical resistance of most liquid foods or foods containing at least one liquid component changes with a transition from a safely edible state to a foul state.

The conductivity sensor, for example, comprises of two electrodes arranged parallel or coaxial to each other. The electrodes are made of stainless steel, graphite or, rarely, pure metals such as platinum or titanium. The electrodes have a defined surface and are located at a defined distance from each other. The liquid between the electrodes behaves like an ohmic resistance, which can be read out e.g. by a conductive measuring method. There are also measuring circuits using the inductive method, which offer the advantage that they can be operated potential-free from the liquid.

Simple electrode structures for conductivity measurement can be produced cost-effectively using printing techniques.

It is advantageous that at least one of the at least one sensors is an oxygen sensor.

By providing a sensor, it is possible to determine one or more properties, for example of a product coming into contact with the web material, in particular with its top layer assigned to the product. In order to be able to determine different properties, it is of course conceivable that the functional element comprises several sensors, in particular different sensors, and/or that the functional element comprises further parts, which then also comprise a sensor, for example.

It is advantageous that at least one of the at least one sensors is a pH sensor.

The pH value is a measure of the acidic or basic character of an aqueous solution. It is determined on the basis of the hydrogen ion activity of the aqueous solution. There are different methods to determine the pH value. One possibility is the application of a potentiometric electrode (potentiometry). Here, the potential, which is directly dependent on the H+ ion concentration at an ion-sensitive electrode, is measured. The measurement is carried out as a potential difference measurement compared to a reference electrode, also known as a reference electrode, which provides a constant potential. Nowadays, the pH glass electrode is particularly well available on the market as a version of a pH electrode. It is usually arranged as a combination electrode with integrated reference electrode.

In addition to glass electrodes, there are other embodiments of potentiometric pH sensors which can also be used with preference in connection with this invention. These include, for example, the ion-sensitive field effect transistor (ISFET) and the EIS (Electrolyte Insulator Semiconductor) sensor. ISFET is a special type of field effect transistor in which the gate contact is replaced by an ion- or pH-sensitive material (e.g. SiO2, Al2O3 or Ta2O5). In principle, the EIS sensor resembles a metal-insulator-semiconductor structure, whereby the metal contact is replaced by the measuring electrolyte and the reference electrode and the insulator by an ion-sensitive layer (e.g. SiO2, Al2O3 or Ta2O5). One advantage of these designs is the possibility of miniaturization. ISFET or EIS structures can be produced using silicon technology. At high production quantities, cost advantages can thus be achieved in the manufacture of the sensors.

The first and/or the electrical element can be equipped with a memory. A memory is understood to be a data memory. This is a storage medium which serves to store electronic data. The data memory can be either a volatile memory or a non-volatile memory or a combination of both memory types. Non-volatile memories are divided into permanent and semi-permanent memories.

Volatile memories are memories whose information is lost if they are not refreshed or if the power is switched off. Non-volatile memories are memories in which the stored information is retained for a longer period of time (at least months) without the presence of an operating voltage. In the case of permanent memories, the information once stored or hardwired remains and cannot be changed. In semi-permanent memories, information can be stored permanently, but the information can also be changed.

The respective memory type should be selected according to the application for which the packaging to be produced from the web material is to be used. Depending on the application there are certain advantages

The data memory can be part of the antenna or transmitter. The data memory can be part of a so-called “tag”, which can be read by radio technology, especially as an RFID tag. The data memory can already be completely or partially written to during the production process of the package material. The data memory can be partially or completely written before it is integrated into the laminate. The data memory can be written with a unique ID. The data memory can be fully or partially written with production data. The data memory can be completely or partially written to on the filling machine. The data memory can be fully or partially written to at one or more points in the value chain. The data memory can be fully or partially written at one or more points in time. The information stored in the data memory can be completely or partially replaced.

With particular advantage, the electrical element comprises at least in parts a transmitting and receiving unit with an antenna and/or a memory and/or a sensor.

According to an embodiment, it is proposed that the barrier layer forms at least part of at least one of the electrical conductors. In particular, the barrier layer can form one of the electrical conductors itself. The barrier layer is preferably metallic to form a gas barrier. This circumstance can be used to enable an electrical line from one side of the barrier layer to the other side of the barrier layer. As explained above, two electrical conductors are preferred which are electrically isolated from each other and extend from one side of the barrier layer to the other side of the barrier layer. One of these conductors can be the barrier layer itself. In this case, a first conductor can be isolated and passed through the barrier layer. The barrier layer itself can form the second conductor. The functional element can be connected to or form one of the conductors on the one hand and be connected to the barrier layer on the other. The electrical element can be connected to the barrier layer so that an electrical path is formed across the barrier layer between the functional element and the electrical element. A second electrical path between the functional element and the electrical element may be formed by the conductor insulated from the barrier layer.

It goes without saying that the functional element is only connected to the electrical element via the two conductors if the electrical conductors are each connected to contacts of the elements. Therefore it is preferred if one contact of one of the elements is connected to at least one of the conductors. The contacts of the elements can form the conductors themselves at least in parts.

According to an embodiment, it is proposed that the barrier layer has a recess and that at least one of the electrical conductors is routed through the recess. During the production of the package material, it is laminated with the respective layers in the transport direction. It is possible that in the course of the transport of the package material, for example, a recess is made in a defined area of the barrier layer, in particular by punching. The recess can also be cut out of the barrier layer using a laser. The area in which the recess is inserted into the barrier layer is preferred in such a way that it lies in the package in the area of a seam, in particular in the area of an overlap between two edges of the blank. In particular, the recess lies in the area of a longitudinal edge or a transverse edge of the blank from which the package is made. The recess is preferably circular, but can also have a different shape. The recess shall preferably have a diameter of less than 5 mm, preferably less than 1 mm. Since the conductors must only have a low current carrying capacity, these diameters may be less than 5 mm, preferably less than 1 mm. Thus the recess can be arranged so that an annular space is formed between the barrier layer and the conductor guided in the recess. This annular space forms the insulation of the conductor against the barrier layer. The recess ensures that a conductor is guided through the barrier layer insulated from the barrier layer.

According to an embodiment it is proposed that the functional element is connected to a layer on the first side of the barrier layer. It is also proposed that the electrical element is connected to a layer on the second side of the barrier layer.

It is possible that sensors and/or antennas are printed as described above. In particular, it is possible to connect a sensor or other functional element in or on the top layer facing the product. In particular, it is possible to connect an antenna or other electrical element in or on the top layer facing away from the product. Also known are electrical elements that are already available as foil-like components. Pre-laminated electrical elements can also contain sensors or antennas. This foil-like element can be bonded to one side of the barrier layer. It is possible that this is done directly on the barrier layer or on the top layer or an intermediate layer. Bonded to a layer in this application can mean on, in or at a layer. Bonding can be done by laminating, printing, gluing, riveting, plugging or the like.

During the manufacture of the web material, it may be possible to unwind laminated electrical elements, which are present, for example, as foil elements, from a roll and to laminate them during the manufacturing process in a continuous application process onto the package material moving during the manufacturing process. A large number of functional elements and/or electrical elements can be unwound from a roll as web material. The elements arranged on the roll or the web material can have a defined distance to each other, so that the elements in the blank are each arranged at the same position.

It has also been recognized that at least one functional element can be integrated into the package laminate between the carrier layer and a top layer and/or at least partially into the carrier layer or top layer to provide the user with the desired information. This simplifies the production of the package laminate and the bonding of the element. This is where the structure-giving and relatively rigid carrier layer can be used. The carrier layer thus forms a suitable substrate for attaching and receiving at least one element. Alternatively or additionally, the carrier layer provides a protective effect with regard to the element so that it can be bonded into the package laminate permanently without damage. For example, the package laminate can easily be rolled up into a roll after manufacture and then moved to another location. The carrier layer protects at least one electronic functional element from damage, in particular from buckling or excessive bending. However, the element can also be protected by the carrier layer during the formation of the package and in the package itself. When the element is at least partially integrated into the top layer, the bending stiffness of the carrier layer can also be used. In addition, the layer thickness of the package laminate can be kept low without having to at least partially incorporate the element into the carrier layer. In addition, this allows the element to make contact with the outside of the package laminate or with the inside of the subsequent package as required.

According to an embodiment, it is proposed that the barrier layer be continuously separated into two separate areas along at least one direction. Thus it is possible to separate the barrier layer with a knife or a laser along the direction of movement of the web material. In the blank, this separation can be either in the area of a longitudinal seam or in the area of a transverse seam. This depends on whether the blanks are turned 90° to the longitudinal direction or not after they have been produced from the web material. As a rule, the blanks are rotated by 90°. In this case, a separation in the longitudinal direction, i.e. in the direction of movement of the web material in the blank of a separation would not be along the longitudinal seam but along the transverse seam. However, it is also possible that the separation of the barrier layer into two separate areas only takes place after the blank has been produced. The blanks can also be moved continuously under a knife or laser. This means that the blanks can also be used to continuously separate the barrier layer along one direction into two separate areas. The separation can preferably run parallel to an edge, in particular to the longitudinal edge or to the transverse edge of the blank.

If such a separation of the barrier layer has taken place, it can form at least parts of one of the two electrical conductors. A first area can form part of a first electrical conductor and a second area can form at least part of a second electrical conductor. Thus, for example, the functional element with its electrical connections can be contacted directly on one of the areas of the barrier layer and the electrical element can also be contacted with one of the connections on one of the areas. Then the electrical line is made possible by the barrier layer over the barrier layer itself, whereby the barrier layer can carry two electrical potentials.

The package material is formed from a laminate of several layers comprising at least a carrier layer, a barrier layer and a top layer. Electrical conductors can be led on one of these layers insulated from the barrier layer. Thus it is possible to guide an electrical conductor on a top layer. It is also possible to guide an electrical conductor on a carrier layer. The electrical conductor is preferably insulated from the barrier layer.

In addition, it may make sense for part of the conductor to be formed by a perforating element. The perforating element can at least partially perforate the conductor path. The perforating element can also at least perforate the barrier layer. The perforating element can be pin-shaped or needle-shaped. In particular, the perforating element may have a disc-shaped head and a pin projecting from it. With the disc-shaped head, the perforating element can rest against the conductive path and with the pin, the perforating element can touch or perforate the barrier layer. In particular, the perforating element may be located in the area where the barrier layer has its recess, as explained above.

It is also possible for the perforating element to be in contact with conductor paths on both sides of the barrier layer. Thus it is possible that a first conductor path is connected to or is part of the functional element and a second conductor path is connected to or is part of the electrical element. The perforating element can then perforate both conductor paths and the barrier layer and electrically connect the conductor paths. The perforating element is preferably metallic. In particular, the perforating element is made of the same metal as the conductor paths. If the barrier layer is part of a conductor, it may be sufficient if the perforating element touches the barrier layer. In this case, the perforating element can establish an electrical contact between the conductor path and the barrier layer. Preferably the disc-shaped head is on the side of the barrier layer that is inside the package. Thus the perforating element is inserted from the inside to the outside of a package through the conductor path and at least in parts through the barrier layer.

The perforation element can also be unwound from a roll and applied to the suitable positions of the web material in a continuous process during the manufacturing process of the package material. It is therefore possible that the conductor paths, which can be foil conductors or printed on, are first applied to the inner top layer and the carrier layer, for example. It is preferable if the conductor paths are applied to the package material on opposite sides, one above the other and aligned with one another. In this way, the perforation element can be pushed through at least parts of the barrier layer perpendicular to the surface of the package material.

According to an embodiment, it is proposed that at least one electrically conductive conductor path is applied to a first layer on the first side of the barrier layer and that a perforating element perforates the conductor path at least partially and/or perforates the layers on the first side of the barrier layer at least partially.

According to an embodiment, it is proposed that at least one of the electrical conductors or conductor paths is applied to a layer on the first side of the barrier layer and to a layer on a second side of the barrier layer, with the respective electrical conductors or conductor paths overlapping each other. This means that in the normal projection of the layers parallel to the surface normal of the layers, the respective conductors or conductor paths lie on top of each other. This simplifies the contacting of the conductors or conductor paths. With the help of a perforation element, which is inserted parallel to the surface normal of the package material through at least the barrier layer or another layer of the package material, the two conductors or conductor paths can be electrically connected to each other on the respective sides of the barrier layer.

It is also possible that after the blank has been made from the package material, two opposite edges of the blank are overlapped and laid on top of each other. In this case, in which the overlapping edges are laid on top of each other, this previously described arrangement of the conductors or conductor paths can ensure that a first conductor or conductor path, which is arranged on the first side of the barrier layer, is in direct contact with the second conductor or conductor path, which is arranged on the second side of the barrier layer, in the area of the overlap. The overlapping edges run parallel to each other. Thus, without perforation of the barrier layer, contacting from the inside to the outside in the package is possible. The edge can be sealed by a sealing strip, which is also placed over the conductor path or conductor located on the inside of the package. Sealing can also be carried out by heat sealing the overlapping top layers. The conductors can also be insulated with a layer which is sealable and sealed with the adjacent top layers.

A first side of the barrier layer can be an inner side of the package. On such a first side, one layer can be the top layer, which is applied directly to the barrier layer. It is possible that the functional element has been applied at least partially and/or one of the electrical conductors or conductor paths between the barrier layer and the top layer. In this case, the electrical conductor can, for example, be formed as a foil conductor and thus be independently insulated from the barrier layer. The functional element, for example the sensor, can also be formed as a foil element, with the electronics laminated into a foil. This foil can be applied to the barrier layer and the functional element is electrically insulated from the barrier layer by the foil of the functional element. The foil can be sealable with at least one of the top layers, in particular it can be made of the same plastic.

It is also possible that the functional element and/or one of the electrical conductors are applied to the side of the top layer facing away from the barrier layer. This can be particularly useful if the functional element and/or the electrical conductor or conductor path are not independently insulated. Then the top layer can form an insulation of the electrical conductor, the conductor path and/or the functional element against the barrier layer. This is particularly useful for printed electronic elements, conductors or conductor path. An adhesion promoter layer can also serve as an insulation layer.

Also for the above mentioned case of through-plating over an overlapping area where two edges of the package material overlap in the overlapping area, in particular a first side of the package material lies on a second side of the package material, in particular an inner side on an outer side, it can be useful to apply the electrical conductor or the conductor path on the side of the top layer facing away from the barrier layer. The conductor path or conductor can then be arranged directly on the surface facing the product. In the filled state, the conductor or conductor path can then be in direct contact with the filled product.

A second side of the barrier layer in the package can face the outside. At least one carrier layer is applied to this second side of the barrier layer. It goes without saying that the sequence in which the layers are applied to each other can first include the carrier layer on which the barrier layer is then applied, which is also meant by the above formulation. The electrical element, a conductor path and/or one of the electrical conductors can be applied between the barrier layer and the carrier layer or on a layer located on the side of the carrier layer facing away from the barrier layer. A layer located on the side of the carrier layer facing away from the barrier layer can be, for example, the outer side of the carrier layer, a top layer applied to the carrier layer, a paint layer or the like. In particular, if a conductor path or an electrical conductor is applied to such an outer layer, in the case of overlapping of the blank or two edges of the blank, through-plating from the inside to the outside can take place in which the conductors or conductor path lie on top of each other.

According to an embodiment, it is proposed that the first side of the barrier layer faces the inner layer of a package and the second side of the barrier layer faces an outer layer of the package.

Another aspect is a blank from a package material according to one of the previous claims. The package material is first produced as web material with relatively wide webs in an endless process. The barrier layer and the inner and outer top layers are bonded to the carrier layer in successive laminating processes. After all layers of the package material have been laminated, the web material is fed to a cutting process. In this cutting process, the blank can be produced and, in particular, folds and peelings can be made on the blank. After cutting, the package material can be turned by 90° so that an edge along the longitudinal direction of the web material becomes an edge along the transverse direction of the blank.

The functional element can be contacted with the electrical element either through the barrier layer or via one of the outer edges of the blank. For example, it is possible that at least one of the conductors is placed around a cut edge of the blank. A cut edge of the blank can be either a longitudinal cut or a cross-section. The blank is formed into a package along the edges. If one of the conductors is formed around such a cut edge, a first part of the conductor may be located in the area of the package on an inside and a second part of the conductor may be located on the other side of the cut edge. This makes it possible to make contact from the inside to the outside. In particular, part of the conductor may be located on the first side of the barrier layer and part of the conductor may be located on the second side of the barrier layer. Thus, one part of the conductor lies on each side of the barrier layer. On the inside, for example, the conductor can be arranged on the inner top layer. It is also possible for the conductor to be located between the top layer and the barrier layer.

On the second side, for example, the conductor can be placed on the barrier layer, on the carrier layer or on an outer top layer. In particular, the conductor can be located between the barrier layer and the carrier layer or between the carrier layer and the top layer.

The conductor is preferably a foil conductor surrounded by an insulating material. The insulation material forming the foil is particularly sealable with the material of the top layer. In particular, the material is the same as the material of the top layer.

It is often the case that the carrier layer is peeled along a longitudinal edge. Then the laminate is turned over in the area of the peeled longitudinal edge and the turned over top layer is sealed with the top layer of the opposite edge. In this case, it may make sense to initially apply only part of the conductor between the barrier layer and the inner top layer or on top of the inner top layer. Only after the conductor has been turned over is it guided outwards from the end that has been turned over to the outer surface layer. The sealing along the adjacent inner surface layers then simultaneously seals the conductor.

A particularly simple arrangement of the conductors as well as simple further processing of the conductors can be achieved if one of the conductors is at an angle, in particular at right angles to a blank edge of the blank. The conductor can be arranged on a top layer running on the first side of the barrier layer. In the area of this top layer, the conductor can run in the area of a cut edge of the blank.

In the area of the cut edge in particular, a subsequent sealing is carried out either by peeling and subsequent turning over and sealing of the top layers one above the other or by overlapping the longitudinal edges and using a sealing strip. In both cases, however, the barrier layer in the area of the cut edge is doubled, so that breaking through the barrier layer in the area of the cut edge, especially in the area of the later sealed seam, is unproblematic with regard to diffusion through the barrier layer. On the one hand, the barrier layer no longer lies directly on the product, on the other hand, the barrier layer is double-set there.

The blank can have a longitudinal and a transverse edge and the conductor preferably runs parallel to the longitudinal edge.

A conductor can be made up of two parts, with a first part as a fixed end fixed to a layer on the first side of the barrier layer. The fixed end may be located directly on the barrier layer, between the barrier layer and the top layer, or on the top layer. A free end can then be present in the blank, which can only be attached to an outer top layer after the package has been formed. This requires that the free end of the conductor protrudes beyond a cut edge. After the package has been formed, the free end protrudes beyond a seam of the package. This free end can then be used to make contact with the electrical element.

The free end can protrude either over a longitudinal seam or a transverse seam. If the free end protrudes beyond a longitudinal seam, it protrudes beyond a seam on the bottom or lid side of the packaging. If the free end is above the transverse edge, it protrudes in the area of a longitudinal seam of the package.

As already explained, the barrier layer can be cut into two parts. In the area of a blank, the separation is continuous along one direction. This means that two electrically isolated areas of the barrier layer are present in one blank. Each of the areas can form at least a part of the electrical conductor.

It is preferable that the separation of the barrier layer does not take place in an area of the blank that can be in direct contact with the product to be packaged in the packaging. It is therefore advisable that the separation between the areas is in the area of a longitudinal edge or a transverse edge, in particular parallel to a longitudinal edge or a transverse edge. In the area of one edge, the blank is closed to the package. There are usually two edges on top of each other. This can be a simple overlap joint or it is possible that one edge is folded over and the overlap lies exclusively in the area of the folded part. If the edge is turned over, it may be useful to peel at least parts of the carrier layer in order to limit the material thickness of the overlap area.

The overlapping edges are sealed. Due to the overlap in the area of the edges, two barrier layers lie on top of each other. In addition, the barrier layer in the overlap area often lies outside the area of the package that is in contact with the product. With a simple overlap joint, at least the outer edge with its barrier layer is outside the area that is in contact with the product. In the case of a folding over, in particular with peeling, the overlapping edges are positioned so that they are not in contact with the product or in the area that comes into contact with the product. In particular, the separation takes place in the area of the edge, which forms an overlapping area of the edges in the packaging. The separation is preferably in the area of the sealing seam of the edge.

As already explained, the barrier layer may have a recess. It has also already been explained that at least one of the electrical conductors is routed through the recess. It is now also proposed that the recess is in the area of a longitudinal edge or a transverse edge. The recess is preferably in an area as previously described for the separation between the two areas of the barrier layer. The recess is in particular in the area of a longitudinal edge or a transverse edge, in particular in the area of a peeling of the longitudinal edge and/or the transverse edge. The recess is also preferred in the area of a sealed seam of the longitudinal edge and/or the transverse edge.

If the blank is folded and sealed along at least one longitudinal edge, this can be referred to as a package sleeve.

If the bottom is then sealed, a package is created in which a product to be packaged can be filled. The functional element is preferably located in the area of a lower half, in particular in the area of a lower third of the package, in particular in the area of the base. This ensures that this functional element can also detect the condition of the product when at least parts of the packaging have been emptied. The packaged goods remain in the area of the bottom, so that sensory detection of the properties of the packaged goods preferably takes place in the area of the bottom. The functional element can either be located on a lateral surface of the package in the area of the base or directly on the base.

In the packaging, the conductor preferably runs along a longitudinal seam or a transverse seam.

According to an embodiment, it is proposed that a sealable top layer is provided in the area of the first side of the barrier layer, that the sealable top layer is sealed in the area of at least one seam, with at least one of the conductors running in the area of the resulting sealed seam.

In particular in the area of an overlap joint without a folded edge, sealing can take place along a longitudinal edge and/or a transverse edge with a sealing strip. Since in the area of a simple overlap joint the inner surface layers no longer lie directly on top of each other, sealing of the surface layers directly can be impossible, for example due to the application of paint. For this reason, secure sealing with a sealing strip is necessary. It is proposed that the conductor be arranged in the sealing strip itself. The sealing strip can then, for example, protrude beyond a transverse edge and/or a longitudinal edge and be folded over after sealing. Thus, the conductor is led through the sealing strip from the inside of the package to the outside of the package.

The perforation element described above weakens the barrier layer. In order to minimise or eliminate the associated risk of contamination of the product, the perforation element is preferably located in the area of the sealing seam. The perforation element can be arranged as described above for the conductor.

The separation of the barrier layer into two areas is also preferably carried out in the area of the sealing seam for the same reasons.

A recess can also be provided in the barrier layer, as described. It is also proposed that this recess be located in the area of the sealing seam. A sealed seam can either be formed by a sealing strip, or by a direct sealing of an inner top layer of an outer top layer, or by a sealing of a turned over inner top layer with an inner top layer resting on it. In all cases, the weakening of the barrier layer may then be in the area which is not directly in contact with the product.

As explained above, the functional element may have at least one sensor and/or one memory. The electrical element can also have a memory. In addition, the electrical element may have a transmitter and/or receiver unit. In particular, this may include a transmitting and/or receiving unit for short-range radio, in particular for NFC technology or RFID technology. In addition, the electrical element can be energetically self-powered, for example by a battery or a capacitor. It is also possible and particularly preferred if the functional element and/or electrical element is energetically externally fed. This energetic external supply can be provided by a magnetic or electric field of a readout unit or a write unit. In particular, an electromagnetic coupling of a receiving coil formed in the electrical element with a transmitting coil can cause the energetic supply. A transmitting coil can be used to induce a current in the receiving coil which can be used to operate the first electronic unit and/or the second electronic unit. For example, it may be useful to activate the sensor by the excitation field and, if activated, to obtain and store at least one sensor reading. If the excitation field is switched off again, at least the stored measured value remains in the memory. Such a measured value can be read out immediately or at a later point in time, at a new excitation, so that at least one historical and/or one current sensor measured value can be read out. Since the elements in the package material must be as simple as possible, it is preferable if they are only set up for recording the measurement results and storing at least one measurement result as well as for transmitting such a measurement result. A subsequent evaluation of the measurement results can take place in a readout device.

The readout device may be a mobile computer, in particular a mobile telephone, a smartphone, a personal digital assistant or the like. This may include an application which is set up to evaluate the measurement results. Such an application can be inventive on its own. The application activates the transmitting coil to energetically feed the first and second electronic units. Via the transmitting coil, for example, information can be received from the electrical element by influencing the alternating flux. The electrical element can also, for example, transmit the information in a different frequency range from that of the excitation field and the transmitting coil or another coil can receive this information. The application can be used to evaluate measured values.

For the sake of completeness, the structure of the layers of the package laminate (packing material) is described in more detail below.

The layers of the layer sequence are bonded to each other. The term “bonded” or “compound” used in this description relates to the adhesion of two objects beyond Van-der-Waals forces of attraction. Unless otherwise stated, the layers can follow one another in the layer sequence indirectly, i.e. with one or at least two intermediate layers, or directly, i.e. without an intermediate layer. For the laminar bond, for example, this means that the barrier layer can be bonded directly and thus directly to the first polyolefin layer or indirectly via an adhesion promoter layer. Furthermore, the further polyolefin layer can also be directly and directly bonded to the carrier layer, but there can also be other objects, for example in the form of further polymer layers, in between, whereby a direct bond is preferred. The formulation “containing a sequence of layers”, as used above, means that at least the indicated layers may be present in the compound according to the subject matter in the indicated sequence. This formulation does not necessarily mean that these layers follow each other immediately.

A first polyolefin layer may be used as a top layer overlying the barrier layer on a side facing away from the carrier layer. A further polyolefin layer can be used as an outer layer overlying the carrier layer on a side facing away from the barrier layer. The further polyolefin layer preferably adjoins the carrier layer.

The first polyolefin layer and the next polyolefin layer, as well as all other polymer layers, may comprise further components. These polyolefin layers are preferably extruded into or applied to the flat composite material. The other components of the polyolefin layers are preferably components that do not adversely affect the behaviour of the polymer melt when applied as a layer. The other components can be inorganic compounds such as metal salts or other plastics such as other thermoplastics. However, it is also conceivable that the other components are fillers or pigments, for example carbon black or metal oxides.

Suitable thermoplastics for the other components are those that are easy to process due to their good extrusion properties. These include polymers obtained by chain polymerization, especially polyesters or polyolefins, with cyclic olefin copolymers (COC), polycyclic olefin copolymers (POC), especially polyethylene and polypropylene, being particularly preferred and polyethylene being particularly preferred. Among the polyethylenes, HDPE, MDPE, LDPE, LLDPE, VLDPE and PE and mixtures of at least two are preferred. Mixtures of at least two thermoplastics can also be used.

Suitable polyolefin layers have a melt flow rate (MFR) in a range from 1 to 25 g/10 min, preferably in a range from 2 to 20 g/10 min and particularly preferably in a range from 2.5 to 15 g/10 min, and a density in a range from 0.890 g/cm³ to 0.980 g/cm³, preferably in a range from 0.895 g/cm³ to 0.975 g/cm³, and further preferably in a range from 0.900 g/cm³ to 0.970 g/cm³. The polyolefin layers preferably have at least one melting temperature in a range from 80 to 155° C., preferably in a range from 90 to 145° C. and particularly preferably in a range from 95 to 135° C. The polyolefin layers preferably have at least one melting temperature in a range from 80 to 155° C., preferably in a range from 90 to 145° C. and particularly preferably in a range from 95 to 135° C. The laminar bond between the barrier layer and the carrier layer preferably comprises a polyolefin layer, preferably a polyethylene layer. Further preferably, the composite precursor between the barrier layer and the carrier layer comprises a polyolefin layer, preferably a polyethylene layer.

As a carrier layer, any material suitable for this purpose by a specialist can be used which has sufficient strength and stiffness to give the packaging sufficient stability that the packaging essentially retains its shape when filled. In addition to a number of plastics, plant-based fibrous materials, in particular cellulose, preferably glued, bleached and/or unbleached cellulose, are preferred, paper and board being particularly preferred. The weight per unit area of the carrier layer is preferably in a range from 120 to 450 g/m², particularly preferred in a range from 130 to 400 g/m² and most preferred in a range from 150 to 380 g/m². A preferred board usually has a single-layer or multi-layer structure and can be coated on one or both sides with one or more top layers. Furthermore, a preferred board has a residual moisture content of less than 20% by weight, preferably from 2 to 15% by weight and particularly preferably from 4 to 10% by weight based on the total weight of the board. A particularly preferred board has a multi-layer structure. Furthermore, the board prefers to have at least one, but especially at least two, layers of a top layer on the surface facing the environment, which is known to experts as a “line”.

In paper production, the term “coating” is used to describe liquid phases containing mostly inorganic solid particles, preferably solutions containing chalk, gypsum or clay, which are applied to the surface of the board. Furthermore, a preferred board has a Scott-Bond value in a range from 100 to 360 J/m², preferably from 120 to 350 J/m² and especially preferred from 135 to 310 J/m². The above-mentioned areas make it possible to provide a composite from which a packaging can be folded with a high degree of impermeability, easily and within small tolerances.

The barrier layer is a metal layer. In principle, all layers with metals that are known to experts and can create a high level of light and oxygen impermeability are suitable as a metal layer. Depending on the preferred embodiment, the metal layer can be in the form of a foil or a deposited layer, e.g. after physical vapour deposition. The metal layer is preferably an uninterrupted layer. According to another preferred embodiment, the metal layer has a thickness in a range from 3 to 20 μm, preferably in a range from 3.5 to 12 μm and particularly preferred in a range from 4 to 10 μm.

Preferred metals are aluminium, iron or copper. A steel layer, e.g. in the form of a foil, may be preferred as the iron layer. Further preferentially the metal layer represents a layer with aluminum. The aluminium layer can comprise of an aluminium alloy, for example AlFeMn, AlFe1,5Mn, AlFeSi or AlFeSiMn. The purity is usually 97.5% and higher, preferably 98.5% and higher, in relation to the entire aluminium layer. In an embodiment, the metal layer comprises of an aluminium foil. Suitable aluminium foils have an elongation of more than 1%, preferably of more than 1.3% and particularly preferred of more than 1.5%, and a tensile strength of more than 30 N/mm², preferably of more than 40 N/mm² and particularly preferred of more than 50 N/mm². In the pipette test, suitable aluminium foils show a drop size of more than 3 mm, preferably more than 4 mm and particularly preferred of more than 5 mm. Suitable alloys for the production of aluminium layers or foils are available under the designations EN AW 1200 , EN AW 8079 or EN AW 8111.

In the case of a metal foil as a barrier layer, an adhesion promoter layer can be provided between the metal foil and the nearest polymer layer on one and/or both sides of the metal foil. In accordance with an embodiment of the invention package, however, no adhesion promoter layer is provided on any side of the metal foil between the metal foil and the nearest polymer layer.

A metal oxide layer may also be preferred as a barrier layer. Metal oxide layers are all metal oxide layers that are familiar to experts and appear suitable for achieving a barrier effect against light, steam and/or gas. Especially preferred are metal oxide layers based on the above mentioned metals aluminium, iron or copper as well as metal oxide layers based on titanium or silicon oxide compounds. For example, a metal oxide layer is produced by vapor deposition of a plastic layer, for example an oriented polypropylene foil with metal oxide. A preferred process for this is physical vapour deposition.

According to another preferred embodiment, the metal layer of the metal oxide layer can be a composite of one or more plastic layers with a metal layer. Such a layer is available, for example, by vapor deposition of metal on a plastic layer, for example an oriented polypropylene film. A preferred process for this is physical vapour deposition.

In order to facilitate the openability of the packaging or the laminar composite, the carrier layer can have at least one recess (synonym: hole, opening). In an embodiment, the recess is at least covered with the barrier layer and at least the first polyolefin layer as top layers. A laminar composite is preferred, with the carrier layer having at least one hole which is covered at least by the barrier layer and at least by the first polyolefin layer, and at least by the further polyolefin layer. In addition, one or more further layers, in particular adhesion promoter layers, may be provided between the layers already mentioned. Here it is preferred that the hole covering layers are bonded together at least partially, preferably at least 30%, preferably at least 70% and particularly preferably at least 90% of the surface formed by the hole.

According to an embodiment, it is preferred that the hole perforates the entire bond and is covered by a closure or opening device closing the hole. In connection with a first preferred type, the hole provided in the carrier layer may have any shape known to the professional and suitable for various closures, straws or opening devices. Usually the opening of a laminar composite or a packaging with a laminar composite is produced by at least partially destroying the hole top layers covering the hole. This destruction can take place by cutting, pressing into the packaging or pulling out of the packaging. Destruction may be effected by an openable closure connected to the packaging and located in the area of the hole, usually above the hole, or by a drinking straw which is pushed through the hole top layers covering the hole.

According to another preferred embodiment, the carrier layer of the composite has a large number of holes in the form of a perforation, the individual holes being covered with at least the barrier layer and one of the first polyolefin layers as the hole top layers. A packaging made of such a composite can then be opened by tearing along the perforation. Such holes for perforations are preferably made with a laser. The use of laser beams is particularly preferred when a metal foil or a metallized foil is used as a barrier layer. It is also possible that the perforation is made by mechanical perforation tools, usually with blades.

All plastics can be considered as adhesion promoters in the adhesion promoter layer which, by functionalisation using suitable functional groups, are suitable for producing a solid bond by forming ion bonds or covalent bonds to the surface of the other layer. These are preferably functionalized polyolefins obtained by co-polymerizing ethylene with acrylic acids such as acrylic acid, methacrylic acid, crotonic acid, acrylates, acrylate derivatives or carboxylic anhydrides containing double bonds, for example maleic anhydride, or at least two of them. These include polyethylene maleic anhydride graft polymers (EMAH), ethylene-acrylic acid copolymers (EAA) or ethylene-methacrylic acid copolymers (EMAA), which are marketed under the trade names Bynel® and Nucrel® by DuPont or Escor® by ExxonMobile Chemicals.

A preferred polyolefin is a polyethylene or a polypropylene or both. A preferred polyethylene is one selected from the group comprising of an LDPE, an LLDPE, and an HDPE, or a combination of at least two of them. Another preferred polyolefin is an mpolyolefin. Suitable polyethylenes have a melt flow rate (MFR) in a range from 1 to 25 g/10 min, preferably in a range from 2 to 20 g/10 min and more preferably in a range from 2.5 to 15 g/10 min, and a density in a range from 0.910 g/cm³ to 0.935 g/cm³, preferably in a range from 0.912 g/cm² to 0.932 g/cm³, and more preferably in a range from 0.915 g/cm³ to 0.930 g/cm³.

An mpolyolefin is a polyolefin produced by a metallocene catalyst. A metallocene is an organometallic compound in which a central metal atom is located between two organic ligands such as cyclopentadienyl ligands. A preferred mpolyolefin is an mpolyethylene or an mpolypropylene or both. A preferred mPolyethylene is one selected from the group comprising of an mLDPE, an mLLDPE, and an mHDPE, or a combination of at least two thereof.

A preferred paint layer comprises colorants in a proportion ranging from 5 to 15 wt. %, preferably from 8 to 15 wt. %, more preferably from 13 to 15 wt. % based on the paint layer. Another preferred ink layer also contains an application medium. An organic medium is a preferred application medium. A preferred organic medium is an organic binder. A preferred organic binder is a thermoplastic. A preferred thermoplastic is polyvinyl butyral (PVB). The color layer preferably adjoins the other polyolefin layer, with the other polyolefin layer preferably adjoining the carrier layer. The ink layer is preferably available by printing. A preferred printing method is offset printing or gravure printing or both. Another preferred ink layer is not overlaid by any other layer of the layer sequence on a side of the ink layer facing away from the carrier layer.

A preferred colorant is a colorant according to the DIN 55943 standard. Another preferred colorant is a pigment or a dye or both. A particularly preferred colorant is a pigment. Another preferred colorant is a natural colorant or a synthetic colorant or both. Another preferred colorant is one selected from the group comprising of a white colorant, a black colorant, and a colorant, or a combination of at least two of them. Another preferred colorant is an effect colorant or a luminescent colorant, or both.

The characteristics of the processes and devices can be freely combined. In particular, characteristics and sub-characteristics of the description and/or of the dependent and independent claims, even by circumventing wholly or in part characteristics or sub-characteristics of the independent claims, may be inventive in their own right, alone or freely combined.

In the following, the subject matter is explained in more detail using a drawing showing embodiments. In the drawing show:

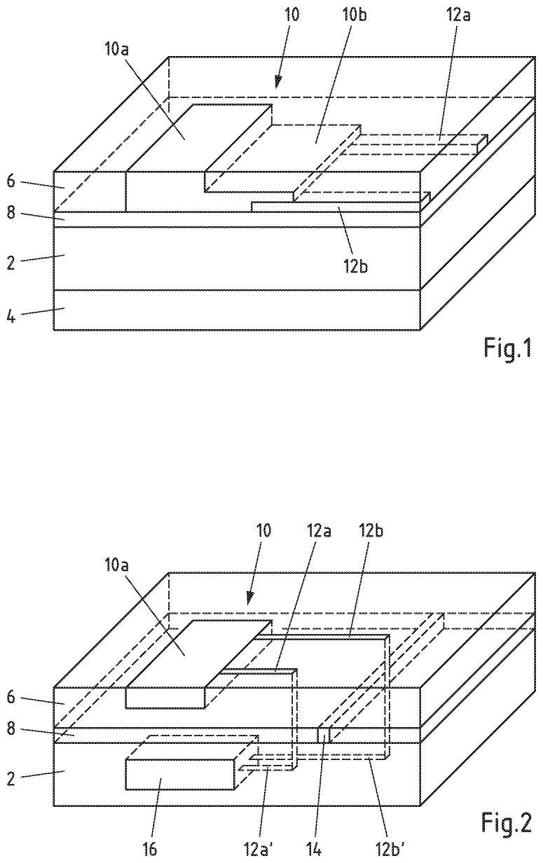

FIG. 1 a schematic view of a first functional element in the package material;

FIG. 2 shows a schematic view of a first and an electrical element in a package material;

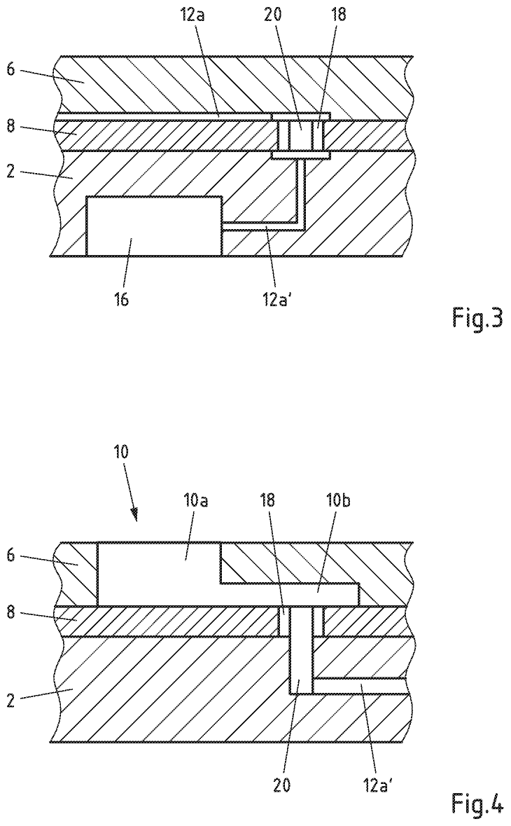

FIG. 3 a schematic view of a conductor passing through a barrier layer;

FIG. 4 a schematic view of a conductor passing through a barrier layer;

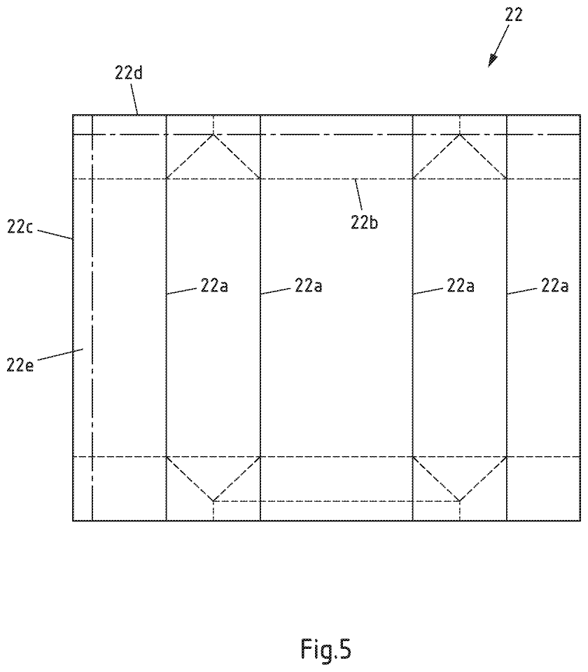

FIG. 5 a blank with potential positions of conductors;

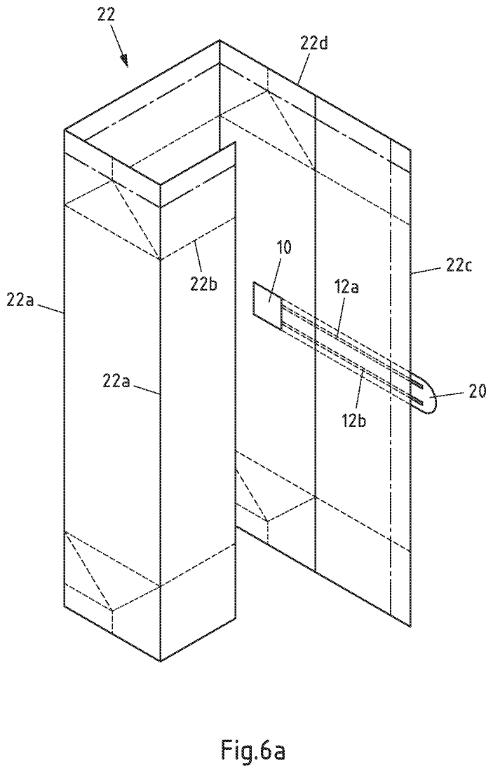

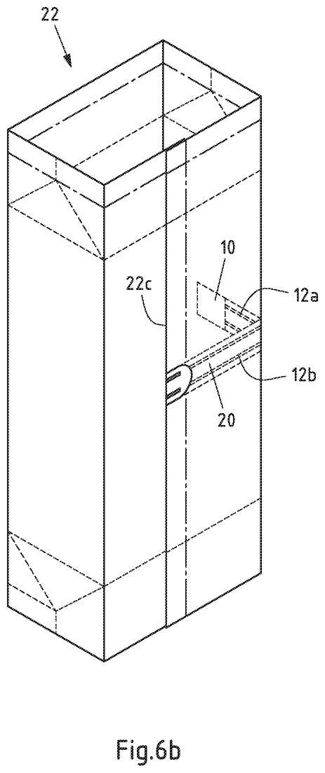

FIG. 6a an open package sleeve;

FIG. 6b a closed package sleeve;

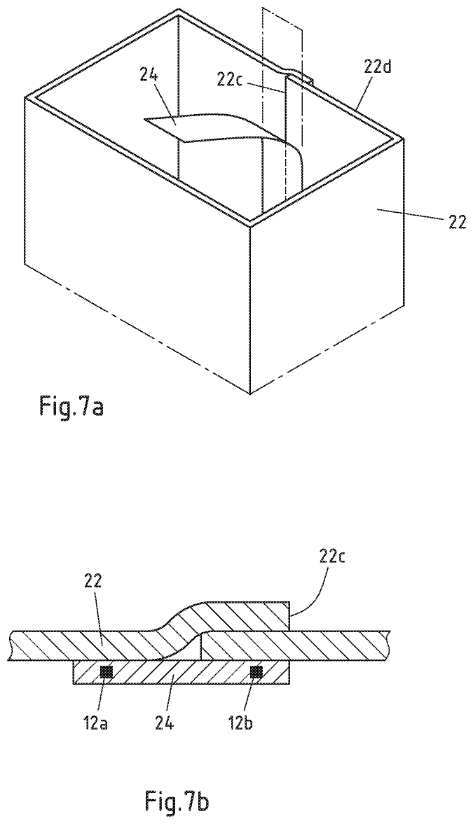

FIG. 7a a package sleeve with a sealing strip;

FIG. 7b a view of a sealing strip;

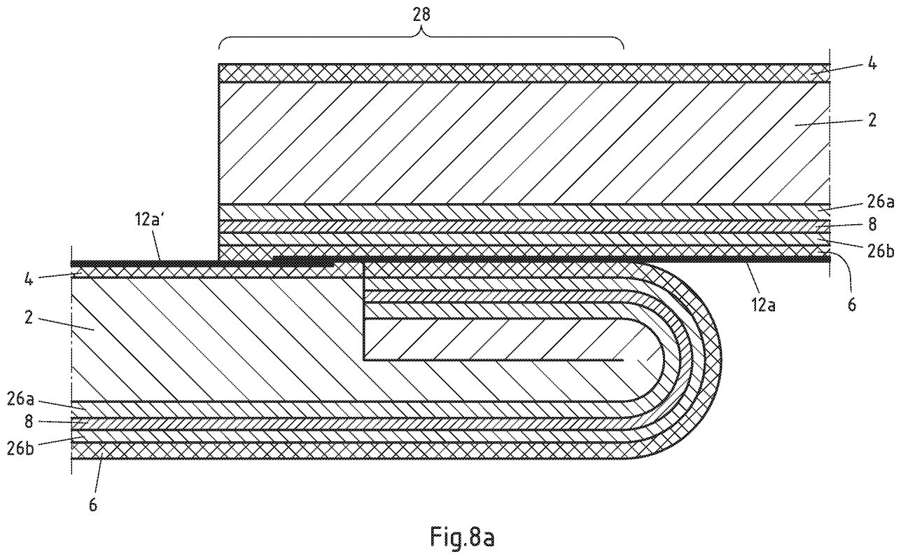

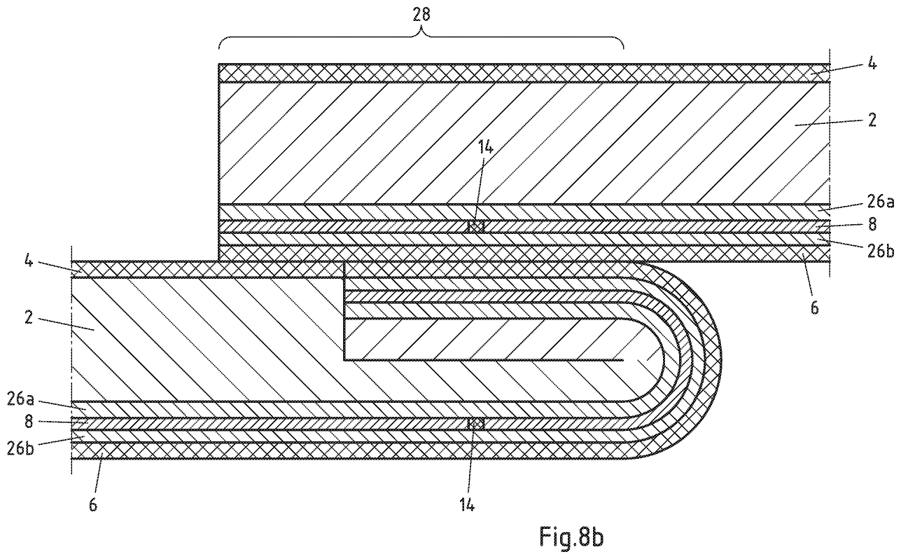

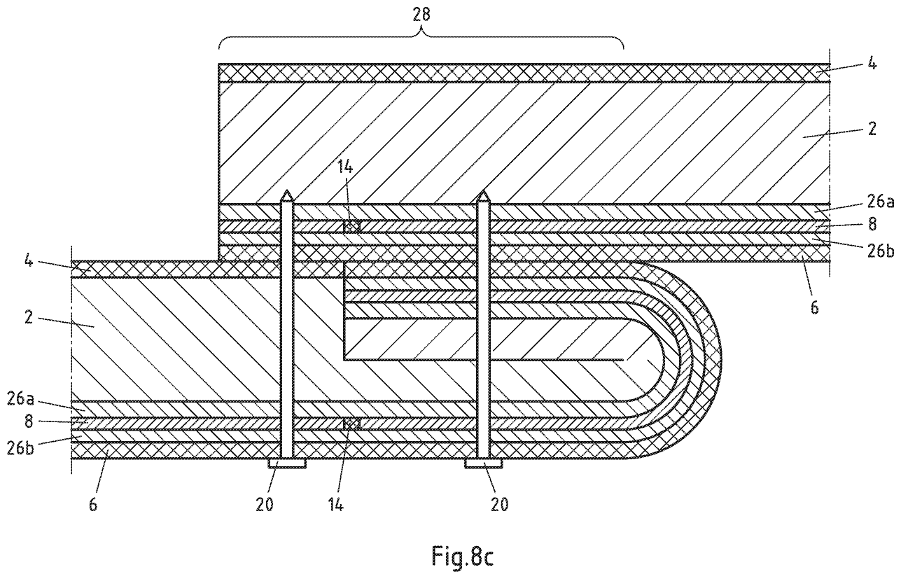

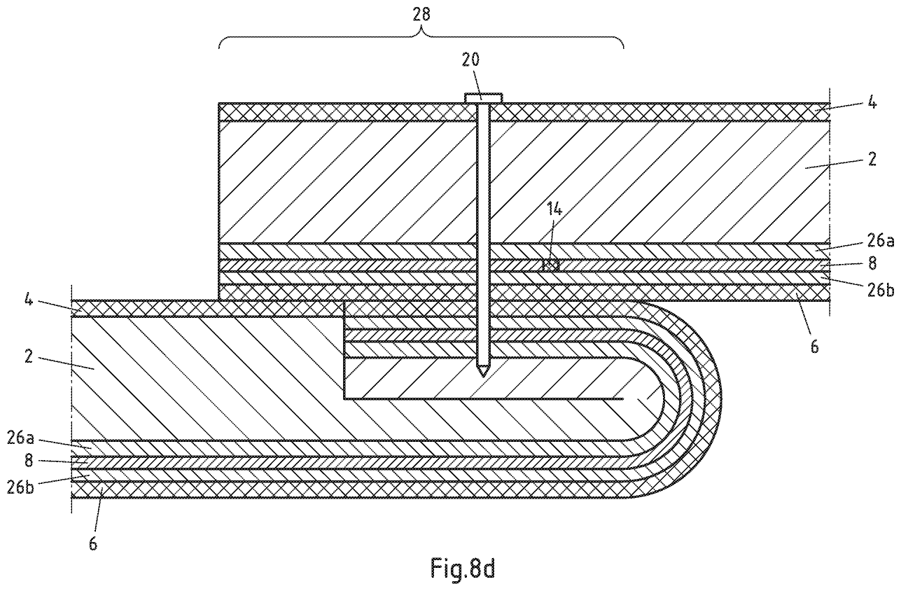

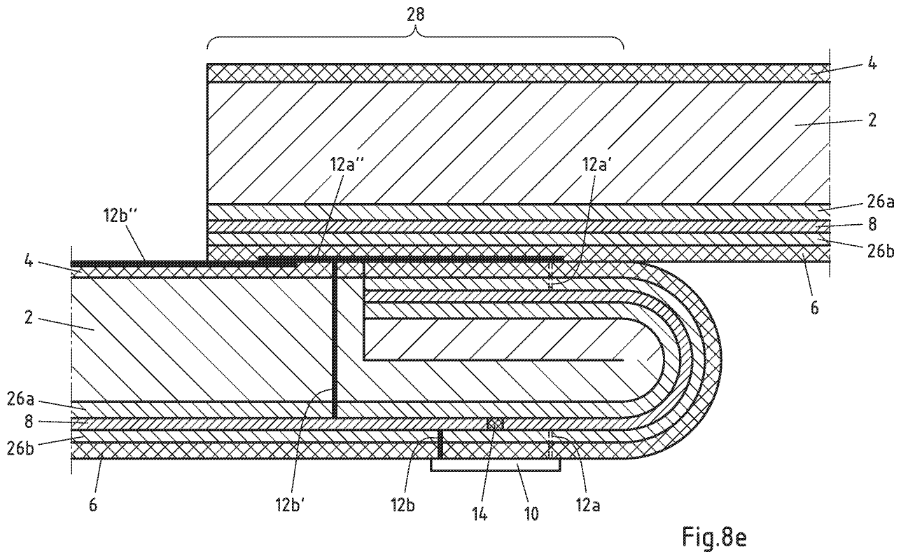

FIG. 8a an embodiment of how to contact a conductor in a sealing seam;

FIG. 8b possible openings in the barrier layer;

FIG. 8c an embodiment of a perforation element;

FIG. 8d an embodiment of a perforation element;

FIG. 8e a possibility of contacting;

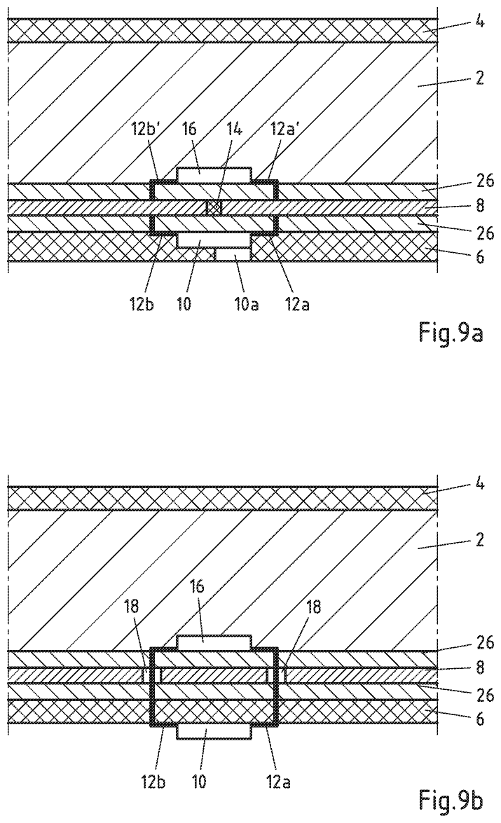

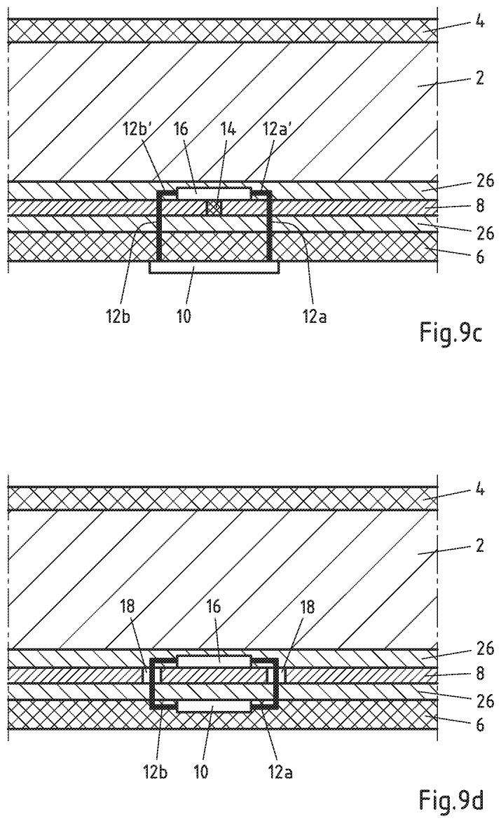

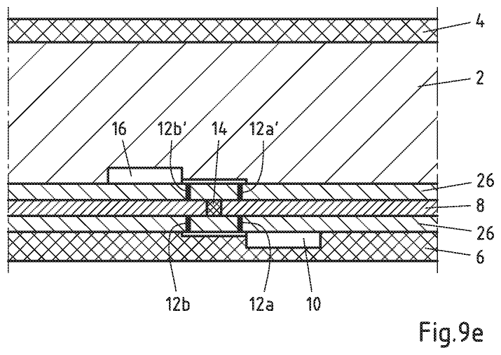

FIG. 9a a contacting along the layer structure;

FIG. 9b an arrangement of conductors and elements in a layered structure;

FIG. 9c a possible feed-through of a conductor in a layered structure;

FIG. 9d another possibility of contacting in a layered structure;

FIG. 9e another possibility of arrangement in a layered structure;

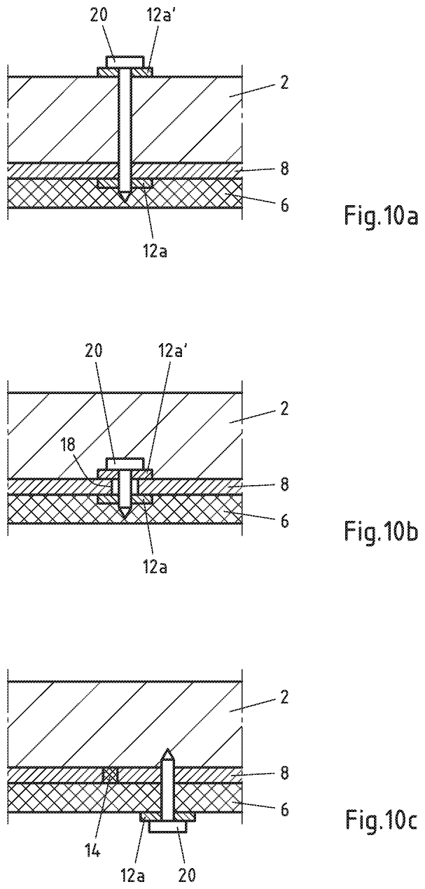

FIG. 10a-c possible arrangements of perforation elements;

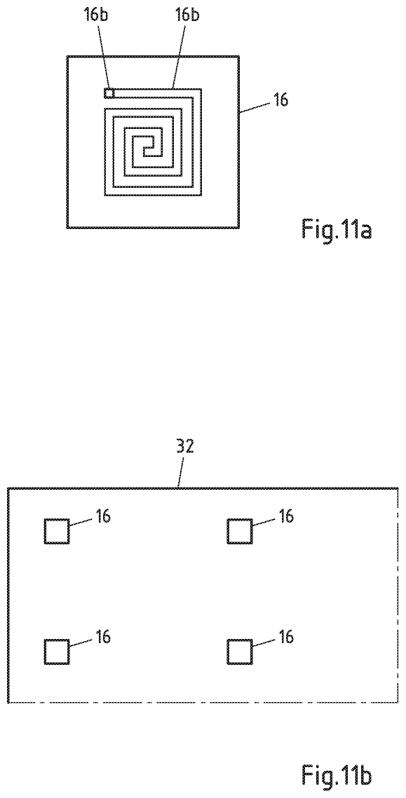

FIG. 11a a schematic view of a transmitting element;

FIG. 11b a schematic view of an arrangement of transmitting elements on an endless belt;

FIG. 1 shows a schematic view of a layered structure of a package laminate (package material). The layer structure can have a carrier layer 2, an outer top layer 4, an inner top layer 6 and a barrier layer 8. The carrier layer 2 is preferably made of a carrier material such as cardboard. The top layers 4, 6 are made of plastic, for example PE, and the barrier layer 8 is metallic, for example aluminium. For further details of the layers, please refer to the explanations above. It goes without saying that this layer structure is purely exemplary.

FIG. 1 shows that the top layer 6, for example, has an integrated sensor 10. The sensor 10 has an area 10a that breaks through the top layer 6 and thus lies on the surface of the top layer. However, the sensor 10 can also have an area 10b which is covered by the surface layer 6. It is also possible that only an area 10a or an area 10b of the sensor 10 is provided. In the range 10a a direct measurement on the product is possible and in the range 10b an indirect measurement on the product is possible.

As can be seen, the sensor 10 is applied to the barrier layer 8. The sensor 10 is isolated from the barrier layer by an insulator. Starting from the sensor 10, two wires 12a, b extend along the barrier layer 8. The wires 12a, b can in particular be foil conductors which are insulated and lie insulated on the barrier layer 8.

To contact the sensor 10 with an electrical element beyond the barrier layer 8, it is necessary to perforate the barrier layer 8. At the same time, the two conductors 12a, b must remain electrically isolated from each other to enable signal transmission. Such a contacting is shown as an example in FIG. 2.

FIG. 2 also shows a carrier layer 2, a barrier layer 8 and a top layer 6. Furthermore a sensor 10 is provided which breaks through the top layer 6 in a range of 10a.

In contrast to FIG. 1, however, conductors 12a and 12b are not formed as foil conductors but, for example, as printed conductors from top layer 8. FIG. 2 also shows that the barrier layer is separated at a separation area 14. The separation area 14 preferably runs parallel to a transverse or longitudinal seam and preferably extends over an entire blank from an upper edge to a lower edge or between two side edges. This ensures that the barrier layer 8 is divided into two areas which are electrically insulated from each other by the separation area 14. This makes it possible to contact conductor 12a with a first part of barrier layer 8 and conductor 12b with a second area. This contact can be made, for example, with the aid of pins that break through the top layer 6.

On the other side of barrier layer 8, in the area of carrier layer 2, the two areas of barrier layer 8 can also be contacted and conductor 12a is continued through conductor 12a′ and conductor 12b through conductor 12b′. The conductor 12a′ is electrically short-circuited to the conductor 12a′ and the conductor 12b′ is electrically short-circuited to the conductor 12b. An electrical insulation is provided between the conductors 12a, b, e.g. by the separation area 14 in the barrier layer 8.

The conductors 12a′, 12b′ contact an electrical element, for example a transmitter 16, which can be equipped with a processor, a memory and an antenna.

The transmitter 16 can, for example, read measured values from the sensor 10 via the conductors 12a, a′, 12b, b′ and make them available wirelessly via an antenna.

FIG. 3 shows another possibility of contacting conductors on both sides of the barrier layer 8. In FIG. 3, the barrier layer 8 is provided with an opening 18. The opening 18 can, for example, be in the form of a punched hole, for example round or angular. Through this opening 18 a contact element 20 can be inserted which is insulated from the barrier layer 8, e.g. via an air gap. Contact element 20 can be connected to conductor 12a on the one hand and conductor 12a′ on the other hand. This contact element 20 is used to connect the two conductors 12a, a′. The same or an alternative can of course also be done for conductors 12b, b′.

FIG. 4 shows another embodiment in which contacting with a contact element 20 can take place directly in the area 10b of the sensor 10. Here the sensor 10 with its range 10b can be arranged above the opening 18. The contact element 20 can be connected directly to a contact on the sensor 10. Furthermore, the contact element 20 establishes a connection with a conductor 12a′. Contact element 20 can be part of sensor 10.

FIG. 5 shows a top view of a blank, for example from the sides of the top layer 6. The blank 22 is characterised by folding edges 22a and folds 22b shown in dotted lines. The type of blank 22 is well known. However, it can be seen that at a longitudinal edge 22c or at a transverse edge 22d there is a preferred area 22e shown with dotted lines, in which the separation area 14 or the opening 18 is arranged. Particularly in the area of the longitudinal edge 22c, the packaging is sealed with the opposite longitudinal edge so that a sealing seam is formed there. In the area of this sealing seam, the separation area 14 or the opening 18 is preferably arranged.

It is also possible to form the contact by means of an element projecting beyond a longitudinal edge 22c or a transverse edge 22d, whereby this element can be bent over after sealing. FIG. 6a shows such an example. FIG. 6a shows a prefolded package sleeve in which the blank 22 is already prefolded in large parts. It can also be seen that a contact element 20 is connected to the conductors 12a, 12b on the one hand with a sensor 10 and on the other hand projects beyond the longitudinal edge 22c. This contact element 20 can, for example, be provided on top layer 6 or between top layer 6 and barrier layer 8 in the production process.

The packaging is then sealed along the longitudinal edge 22c, as shown in FIG. 6b. The edges are preferably sealed together so that a top layer 6 is heat-sealed with a top layer 4. After the sealing process, the contact element 20 is then located inside the package on the one hand and outside the package on the other and is passed through the sealing seam. Finally, the protruding part can be placed around the longitudinal edge 22c.

It is also possible to provide a sealing strip 24 with the lines 12a, b. FIG. 7a shows another example of a package sleeve in which the longitudinal edges are laid on top of each other. In this example, blank 22 is sealed by a sealing strip 24 which is placed over the seam. The sealing strip 24 preferably runs along the entire longitudinal seam 22c. The sealing strip 24 can be arranged so that it protrudes beyond the upper or lower edge. After sealing, the sealing strip 24 is arranged along the longitudinal edge and protrudes beyond the transverse edge 22d of the package sleeve, as shown by the dashed lines. After closing the transverse edge, the sealing strip can be contacted from the outside and in particular the lines 12a, b. If there is no longitudinal seam, e.g. in a tube, a contact element 20 formed as a strip can also protrude from a transverse edge 22d instead of as shown in FIG. 6b. The contact element 20 is formed as a strip. Then the contact element 20 can be provided without sealing function.

FIG. 7b shows a cut through such a sealing strip 24. It can be seen that the conductors 12a, b can be guided in the sealing strip 24.

FIG. 8a-e show an embodiment of a sealing of a longitudinal or transverse edge with a peeling of the carrier layer 2 and a folding over of a longitudinal edge 22c, as is known from the state of the art. The contacting of conductors through the sealing seam is shown as an example in FIG. 8a-e. FIG. 8a-e each refer to a cutout 30 in the area of the sealing seam 28.

FIG. 8a shows a cutout along a sealing seam, e.g. along the longitudinal edge 22c. The laminate is formed from carrier layer 2, an outer top layer 4, an inner top layer 6, a barrier layer 8 as well as hardfacing layers 26a, b. The laminate is made up of the following layers: the carrier layer 2, an outer top layer 4, an inner top layer 6, a barrier layer 8 and hardfacing layers 26a, b. FIG. 8a shows how two opposite longitudinal edges are laid on top of each other, with one edge folded over in the area of a sealed seam 28. In the area of the sealing seam 28, the top layer 6 of a first longitudinal edge thus lies directly against the top layer 6 of the second longitudinal edge. At this direct contact, the wearing courses 6 are sealed together.

FIG. 8a also shows that in the area of the sealing seam 28, the carrier layer 2 is tapered, for example by peeling.

FIG. 8a shows, for example, a ladder 12a′ resting on an outer top layer 4. The ladder 12a rests on the inner surface layer 6. In the area of sealing seam 28, conductors 12a and 12a′ overlap in such a way that an electrical contact can be formed. An electrical contact formed in this way makes it possible to form an electrical line between an inner side of a package and an outer side of a package. However, the sealing seam 28 keeps the packaging sealed.

FIG. 8b shows another embodiment example in which the separation area 14 in the barrier layer 8 is also arranged in the area of the sealing seam 28. If the separation area 14 or also an opening 18 in the area of the sealing seam 28, this has no negative effect whatsoever on the tightness of the barrier layer 8. In the area of the sealing seam 28, the barrier layer 8 lies twice on top of each other and the sealing seam 28 thus represents an extremely tight barrier. A separation area can also be provided cumulatively or alternatively in the area of the barrier layer 8, which faces the interior of the packaging, in particular the product. The separation area 14 can thus be in the area of the barrier layer 8 in which the peeling takes place. The separation area 8 can be in the outer layer of the package sleeve, which is covered by an inner layer. Alternatively or cumulatively, the separation area 14 may be in an inner layer of the sleeve, which is directly in contact with the inside of the package, in particular the product.

FIG. 8c shows another example in which a contact element 20 breaks through some of the layers in the area of the sealing seam. In particular, the contact element breaks through the two barrier layers 8, which lie on top of each other in the area of the sealing seam 28. Two contact elements 20 arranged next to each other can also break through the barrier layer 8. A separation area can be provided between the contact elements 20 in the barrier layer 8 in any position of the package sleeve.

The contact element 20 can also be partially insulated in the arrangement in FIGS. 8c and d and also independently of this. In particular, a first end of the contact element 20 may be coated with an insulator or formed from an insulator and a second end may also be an electrical conductor, e.g. metal. The head of the contact element 20 can be made of a metal or a plastic. The end facing the head can be electrically insulating. The tip, i.e. the end facing away from the head, can be electrically conductive.

FIG. 8d shows another embodiment in which the contact element 20 breaks through the barrier layer 8 from above with its plate-shaped head and also breaks through the lower barrier layer 8.

FIG. 8e shows another embodiment of contacting a sensor 10 arranged on an inner top layer 6. For this purpose, the sensor has 10 wires 12a, 12b, which are led up to the barrier layer 8. The barrier layer 8 is divided into two areas by a separation area 14 and in each of these areas a conductor 12a′, 12b′ is led up to the barrier layer 8. The two conductors are each contacted with 12a″, 12b″ conductors arranged on the inner top layer 8, which in turn are contacted with 12a′″, 12b′″ conductors arranged on the outer top layer 6. This allows through-plating in the area of the sealing seam 28 from the inside of a package to the outside of the package.

FIG. 9a-e again shows a layered structure of a package material formed from a top layer 4, a carrier layer 2, a barrier layer 8 and a top layer 6. The barrier layer 8 is each surrounded by an adhesion promoter layer 26, which can in particular be formed as an insulator. The top layer 6 preferably faces the interior of a package, whereas the top layer 4 faces the exterior of the package.

FIG. 9a shows a possibility of separating the barrier layer 8 along a separation area 14. A sensor 10 can break through the inner top layer 6 in an area 10a and thus carry out a direct measurement. However, it is also possible that the sensor 10 performs only indirect measurements and is not in direct contact with the product to be packaged. Starting from the sensor 10, 26 lines 12a, b can be formed on the adhesion promoter layer, which break through this layer 26 and are connected to the respective areas of the barrier layer 8. On the outside of the packing, conductors 12a, b can also be connected to a transmitter 16, which is arranged on the outer adhesion promoter layer 26 and thus lies within the carrier layer 2.

FIG. 9b shows another embodiment in which the barrier layer 8 is perforated by openings 18, which can be round, for example, punched. The conductors 12a, b are guided through these openings in an insulated manner and contact the sensor 10 with the transmitter 16.

FIG. 9c shows another embodiment in which the sensor 10 is arranged on the inner surface layer 6. The barrier layer 8 is divided in two by a separation area 14. Conductors 12a, b contact the sensor 10 with the two parts of the barrier layer 8. A transmitter 16 applied to the barrier layer 8, which can be insulated from the barrier layer 8, is contacted with conductors 12a′, b′ at the respective areas of the barrier layer 8, so that a two-pole connection is formed between the sensor 10 and the transmitter 16.

FIG. 9d shows a similar embodiment as FIG. 9c. In contrast, the sensor 10 is arranged inside the inner top layer 6 and the transmitter 16 rests on the barrier layer 8.

FIG. 9e shows another embodiment in which a separation area 14 divides the barrier layer 8 into two areas. Each area is connected to a conductor 12a, b of the sensor 10 and a conductor 12a′, b″ of the transmitter 16.

FIG. 10a shows an embodiment in which a conductor 12a rests on the barrier layer 8 isolated from the barrier layer 8. A conductor 12a′ rests on the carrier layer 2. A contact element 20 can break the conductors 12a, a′ and simultaneously the carrier layer 2 and the barrier layer 8. The contact element 20 is preferably electrically insulated from the barrier layer 8.

FIG. 10b also shows an embodiment in which the conductors 12a, a′ rest directly on the barrier layer and are especially insulated against this. A contact element 20, which breaks through the conductors 12a, a′, allows the overlapping conductors 12a, a′ to be contacted.

The contact element 20 is preferably insulated from the barrier layer 8 or guided in an opening 18 of the barrier layer 8.

FIG. 10c shows another embodiment in which conductor 12a, for example, is printed on the inner top layer 6. The contact element 20 pierces this conductor 12a and thus contacts the overlapping conductor 12a. A contact pin of the contact element 20 also breaks through the barrier layer 8 and thus contacts the conductor 12a with the barrier layer 8. A separation area 14 is provided in the barrier layer 8 so that the barrier layer 8 is divided into two areas. In the other area a similar contact can be made with a conductor 12b and a further contact element 20. The contact element 20 can project into the carrier layer 2.

FIG. 11a shows a transmitter 16. It can be seen that the transmitter 16 has an antenna structure 16a as well as a processor 16b and, if necessary, a memory.

Such a transmitter 16 can, for example, be mounted on a foil web 32 and arranged at defined distances from it. Such a foil web 32 can be used in the manufacturing process to apply a transmitter 16 to carrier layer 2 or top layer 4 for one blank at a time. The same applies, of course, to a sensor 10, which can be applied in a similar way to the top layer 6 or the barrier layer 8.

### REFERENCE SIGN LIST

2 Carrier layer

4 Top layer

6 Top layer

8 Barrier layer

10 Sensor

10a, b Range

12a, b Conductor

14 Separation area

16 Transmitter

18 Perforation

20 Contact element

22 Blank

22a Folding edge

22b Folding

22c Longitudinal edge

22d Transverse edge

22e Range

24 Seal strips

26 Bonding agent layer

28 Sealing seam

30 Detail

32 Foil web

1-31. (canceled)

32. A blank from a package laminate for forming a package for flowable products with
at least one carrier layer,
an electrically conductive barrier layer and
a top layer, wherein
a functional element is arranged on a first side of the barrier layer, and
an electrical element is arranged on the second side of the barrier layer facing away from the functional element, wherein
the functional element is connected to the electrical element via at least two mutually insulated electrical conductors
wherein,
the first side of the barrier layer faces an inner layer of a package, and in that the second side of the barrier layer faces an outer layer of a package and
at least one of the conductors is laid around a cut edge of the blank so that a portion of the conductor is disposed on the first side of the barrier layer and a portion of the conductor is disposed on the second side of the barrier layer.

33. The blank according to claim 32,
wherein
the functional element has a sensor and/or in that the electrical element has a transmitter and/or an antenna.

34. The blank according to claim 32,
wherein
the barrier layer forms at least part of one of the electrical conductors.

35. The blank according to claim 32,
wherein
the barrier layer has a recess, and in that at least one of the electrical conductors is passed through the recess.

36. The blank according to claim 32,
wherein
the functional element is connected to a layer on the first side of the barrier layer and/or in that the electrical element is connected to a layer on the second side of the barrier layer.

37. The blank according to claim 32,
wherein
the barrier layer is continuously separated into two regions which are separated from one another along at least one direction, and in that a first region forms at least part of the first electrical conductor and/or in that a second region forms at least part of the second electrical conductor.

38. The blank according to claim 32,
wherein
at least part of one of the electrical conductors is in each case applied to a layer on the first side of the barrier layer and a layer on the second side of the barrier layer, the respective parts partially overlapping one another.

39. The blank according to claim 32,
wherein
at least one covering layer is applied to the first side of the barrier layer, and in that the functional element and/or one of the electrical conductors is applied or introduced between the barrier layer and the covering layer or on the side of the covering layer facing away from the barrier layer.

40. The blank according to claim 32,
wherein
at least one carrier layer is applied to the second side of the barrier layer and in that the electrical element and/or one of the electrical conductors is applied or introduced between the barrier layer and the carrier layer or on a layer which is arranged on the side of the carrier layer facing away from the barrier layer.

41. The blank according to claim 32,
wherein
at least one of the conductors extends at an angle, in particular at right angles to a cut edge of the blank.

42. The blank according to claim 32,
wherein
at least one of the conductors extends on a top layer arranged on the first side of the barrier layer in the region of a cut edge of the blank.

43. The blank according to claim 32,
wherein
a fixed end of at least one conductor is fixed arranged on the first side of the barrier layer, and in that a free end of the at least one conductor projects beyond a blank edge.

44. The blank according to claim 32,
wherein
the blank has at least one longitudinal edge and one transverse edge, and in that at least one of the conductors runs parallel to the longitudinal edge.

45. The blank according to claim 32,
wherein
the free end of the conductor projects beyond a longitudinal edge or a transverse edge.

46. The blank according to claim 32,
wherein
the barrier layer is continuously separated into two regions which are separated from one another along at least one direction, and in that a first region forms at least part of the first electrical conductor and/or in that a second region forms at least part of the second electrical conductor, the separation between the regions being in the region of a longitudinal edge or a transverse edge, in particular in the region of a peeling of the edge or a sealed seam of the edge.

47. The blank according to claim 32,
wherein
the barrier layer has a recess and in that at least one of the electrical conductors is passed through the recess, the recess being in the region of a longitudinal edge or a transverse edge, in particular in the region of a peeling of the longitudinal edge and/or the transverse edge, preferably in the region of a sealed seam of the longitudinal edge and/or the transverse edge.

48. A sleeve made of a blank according to claim 32.

49. The sleeve according to claim 48,
wherein
at least one of the conductors extends in the region of a longitudinal seam or a transverse seam.

50. The sleeve according to claim 48,
wherein
a sealable top layer is provided in the region of the first side of the barrier layer, in that the sealable top layer is sealed in the region of at least one seam, at least one of the conductors running in the region of the sealed seam.

51. The sleeve according to claim 48,
wherein
a seam along a longitudinal edge or a transverse edge is sealed with a sealing strip, and in that at least one of the conductors is arranged in the sealing strip.

52. The sleeve according to claim 48,
wherein
the separation of the barrier layer between the two areas is arranged in the area of the sealing seam.

53. The sleeve according to claim 48,
wherein
the recess in the barrier layer is arranged in the area of the sealing seam.

54. A package made of a sleeve according to claim 48.

55. Packaging made of a package according to claim 54.
